(19) United States
(12) Patent Application Publication
(10) Pub. No.: US 2007/0291469 A1
(43) Pub. Date: Dec. 20, 2007

(54) Switch panel assembly with a light-guiding rod

(76) Inventor: Wen-Pin Chen, Tainan Hsien (TW)

Correspondence Address: Frenkel & Associates, P.C.;Suite 330, 3975 University Drive, Fairfax, VA, 22030, US

(21) Appl. No.: 11/455,053

(22) Filed: Jun. 15, 2006

(51) Int. Cl. F21V 33/00

(52) U.S. Cl. 362/95

(57) ABSTRACT

A switch panel assembly is mounted on a wall and has a switch panel, a light-guiding rod, a circuit board and a switch. The switch panel has two lamp holders formed on and protruding from the switch panel. The light-guiding rod is mounted between the two lamp holders. The circuit board has at least one lamp held in the lamp holders and an optical sensor held in one of the lamp holders. The switch is connected electrically to an illuminating device. The optical sensor is used to detect ambient lights such that the at least one lamp can be automatically lighted up when an ambient environment is dark. The light-guiding rod guides, refracts and scatters the lights emitting from the lamp to brighten the ambient environment for a people easily and quickly finding and switching the switch.

### BACKGROUND OF THE INVENTION

1. Field of the Invention

The present invention relates to a switch panel assembly and more particularly to a switch panel assembly with a light-guiding rod.

2. Description of the Related Art

Room illuminating device, such as fluorescent tubes or ceiling fixtures are connected electrically to a switch mounted in a switch panel assembly and are turned on/off by switching on/off the switch.

A conventional switch panel assembly in accordance with the prior art is always equipped with a light bulb or an LED as a position indicator to emit light in a dark environment. Consequently, a user can quickly find out a switch of the switch panel assembly to turn on the light. However, the light bulb or the LED cannot provide enough luminance to light up an environment around the switch panel assembly. Thus, a user can only see a light-spot and have to cautiously approach the switch panel assembly to keep from bumping with another object.

To avoid the foregoing situation, an auxiliary light is necessary for lighting up the environment around the switch panel assembly, but the environment is also dark and a switch of the auxiliary light is hard to find before the auxiliary light is turned on. The auxiliary light can be keep bright all night, but this wastes energy and money and is too harsh for sleeping people.

### SUMMARY OF THE INVENTION

The primary objective of the present invention is to provide a switch panel assembly with a light-guiding rod to automatically emit mild lights to light up an ambient environment around the switch panel assembly when the ambient environment is dark.

The switch panel assembly in accordance with the present invention is attached to a junction box mounted in a wall and comprises a switch panel, a light-guiding rod, a circuit board and a switch.

The switch panel is mounted on the wall and has a front surface, a rear surface, a switch slot and two lamp holders. The switch slot is formed through the switch panel. The lamp holders are formed on and protrude from the front surface of the switch panel. Each of the lamp holders has a lamp space defined inside and communicating with the rear surface of the switch panel.

The light-guiding rod is mounted on the switch panel between the two lamp holders and has two opposite ends respectively engaging with the lamp holders.

The circuit board is attached to the rear surface of the switch panel and has at least one lamp and an optical sensor. The at least one lamp is mounted on and protrudes from the circuit board and is held in the lamp spaces of the lamp holders. Lights generated by the at least one lamp emit out of the lamp holders and into the light-guiding rod to be guided, refracted and scattered by the light-guiding rod and generate mild lights to light up an ambient environment around the switch panel assembly.

The optical sensor is mounted on and protrudes from the circuit board, is held in one of the lamp spaces of the lamp holders and is connected electrically to the at least one lamp. The optical sensor is used to detect ambient lights around the switch panel assembly. When the ambient environment is dark, the optical sensor outputs a signal to light up the at least one lamp.

The switch is mounted in the switch slot in the switch panel and is connected electrically to an illuminating device to switch the room lighting.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a switch panel assembly with a light-guiding rod in accordance with the present invention;

FIG. 2 is an exploded perspective view of the switch panel assembly in FIG. 1 showing a front side of the switch panel assembly in FIG. 1;

FIG. 3 is an exploded perspective view of the switch panel assembly in FIG. 1 showing a rear side of the switch panel assembly in FIG. 1;

FIG. 4 is a side view in partial section of the switch panel assembly in FIG. 1; and

FIG. 5 is an exploded perspective view of a second embodiment of the switch panel assembly with a light-guiding rod in accordance with the present invention.

### DETAILED DESCRIPTION OF THE PREFERRED EMBODIMENT

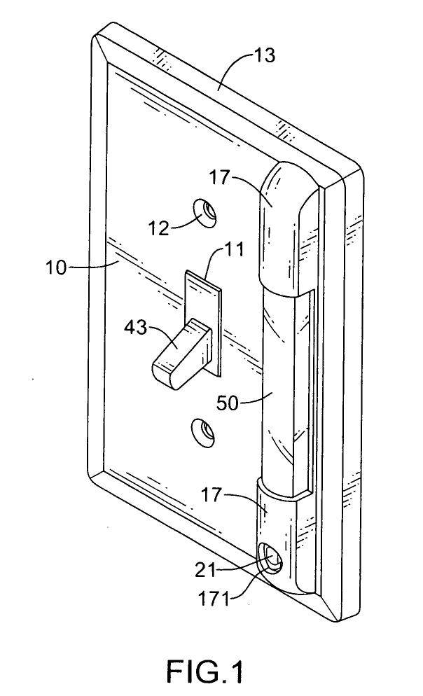

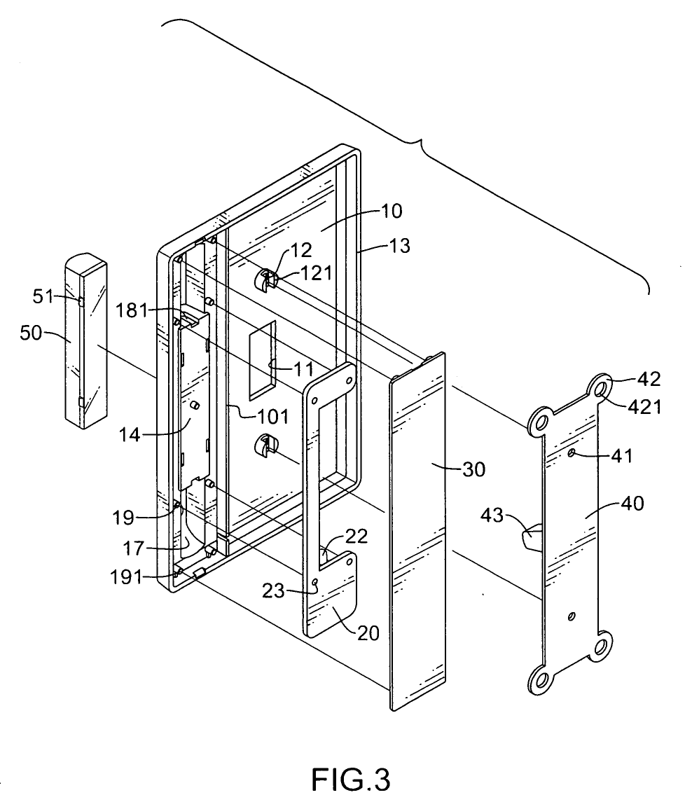

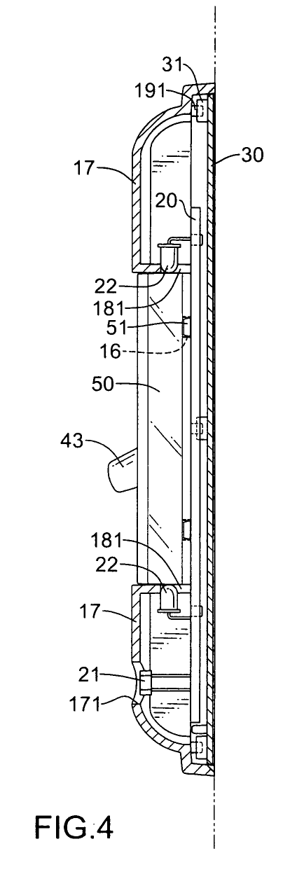

With reference to FIGS. 1-5, a switch panel assembly with a light-guiding rod in accordance with the present invention is attached to a junction box mounted in a wall and comprises a switch panel (10), a light-guiding rod (50), a circuit board (20), an optional covering panel (30), a switch (43) and an optional positioning panel (40).

The switch panel (10) is attached to the wall, covers the junction box, has a front surface, a rear surface, an outer edge, an optional skirt (13), a switch slot (11), two lamp holders (17), an optional sensing hole (171), an optional partition wall (101), an optional elongated recess (14), multiple optional mounting holes (12), multiple optional mounting rods (121), multiple optional first connecting rods (19), multiple optional second connecting rods (191) and may be transparent. The skirt (13) is formed around the outer edge of the switch panel (10) and abuts against the wall. The switch slot (11) is formed through the switch panel (10).

The lamp holders (17) are formed on and protrude from the front surface of the switch panel (10). Each of the lamp holders (17) has a front side, a lamp space and an optional through hole (181). The lamp space is defined inside the lamp holder (17) and communicates with the rear surface of the switch panel (10). The through hole (181) of the lamp holder (17) is formed through the lamp holder (17), communicates with the lamp space of the lamp holder (17) to allow lights to emit out of the lamp holder (17). The through holes (181) of the two lamp holders (17) faces to each other.

The sensing hole (171) is formed through the front side of one of the lamp holders (17) to allow ambient lights to enter into the lamp holder (17). The partition wall (101) is formed on and protrudes from the rear surface of the switch panel (10) between the lamp holders (17) and the switch slot (11) and defines an elongated space. The elongated space is encompassed by the partition wall (101) and part of the skirt (13) of the switch panel (10) and communicates with the lamp spaces of the lamp holders (17). The elongated recess (14), is formed in the front surface of the switch panel (10) between the two lamp holders (17) and has a sidewall (15) and multiple optional detents (16). The detents (16) are formed in the sidewall (15) of the elongated recess (14) and may communicate with the rear surface of the switch panel (10).

The mounting holes (12) are defined through the switch panel (10) around the switch slot (11). The mounting rods (121) are formed on and protrude from the rear surface of the switch panel (10) and respectively correspond to the mounting holes (12) of the switch panel (10). Each of the mounting rods (121) has a mounting slot. The mounting slot of the mounting rod (121) is defined through the mounting rod (121) and communicates with a correspond one of the mounting holes (12) of the switch panel (10).

The first connecting rods (19) are formed on and protrude from the rear surface of the switch panel (10) in the elongated space. The second connecting rods (191) are formed on and protrude from the rear surface of the switch panel (10) in the elongated space.

The light-guiding rod (50) is mounted on the switch panel (10) between the two lamp holders (17), has a surface, two opposite ends and multiple optional bosses (51) and may be mounted in the elongated recess (14) of the switch panel (10). The two opposite ends of the light-guiding rod (50) respectively abut against the lamp holders (17) and align with the through holes (181) of the lamp holders (17) such that the lights emitting out of the lamp holders (17) can be guided, refracted and scattered by the light-guiding rod (50) to light up an ambient environment around the switch panel assembly and generate mild lights. The bosses (51) are formed on the surface of the light-guiding rod (50) and are respectively mounted in the detents (16) of the elongated recess (14).

The circuit board (20) is attached to the rear surface of the switch panel (10), has a control circuit, at least one lamp (22), an optical sensor (21) and multiple optional mounting holes (23) and may be implemented in several ways. The control circuit is mounted on the circuit board (20) and is connected electrically to power lines in the junction box. The at least one lamp (22) is mounted on and protrudes from the circuit board (20), is held in the lamp spaces of the lamp holders (17), is connected electrically to the control circuit of the circuit board (20) to emit lights and may be at least one light bulb or at least one LED and is aligned with at least one end of the light-guiding rod (50) to make light emitting from the at least one lamp to be guided, refracted and scattered by the light-guiding rod.

The optical sensor (21) is mounted on and protrudes from the circuit board (20), is held in the lamp space of one of the lamp holders (17), is connected electrically to the control circuit of the circuit board (20) and may align with the sensing hole (171) in the corresponding lamp holder (171) to sense the ambient lights entering into the sensing hole (171). Accordingly, the optical sensor (21) can detect the ambient environment being dark or bright and outputs a signal to the control circuit for switching on/off the at least one lamp (22). The mounting holes (23) are formed through the circuit board (20) and are respectively and securely mounted around the first connecting rods (19) of the switch panel (10).

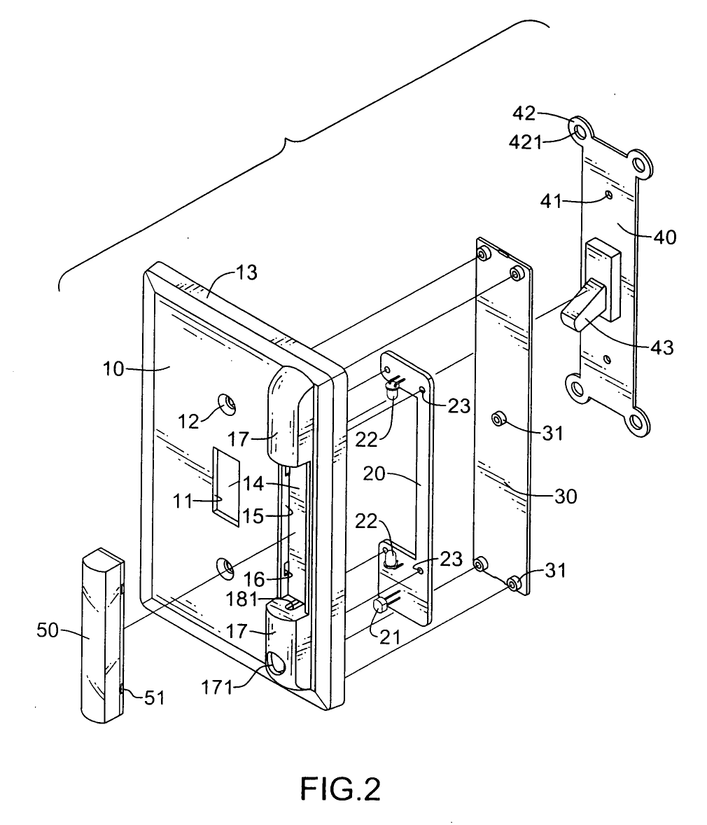

With further reference to FIG. 2, in a first embodiment of the circuit board (20), the circuit board (20) has two lamps (22). The two lamps (22) are held respectively in the lamp spaces of the two lamp holders (17).

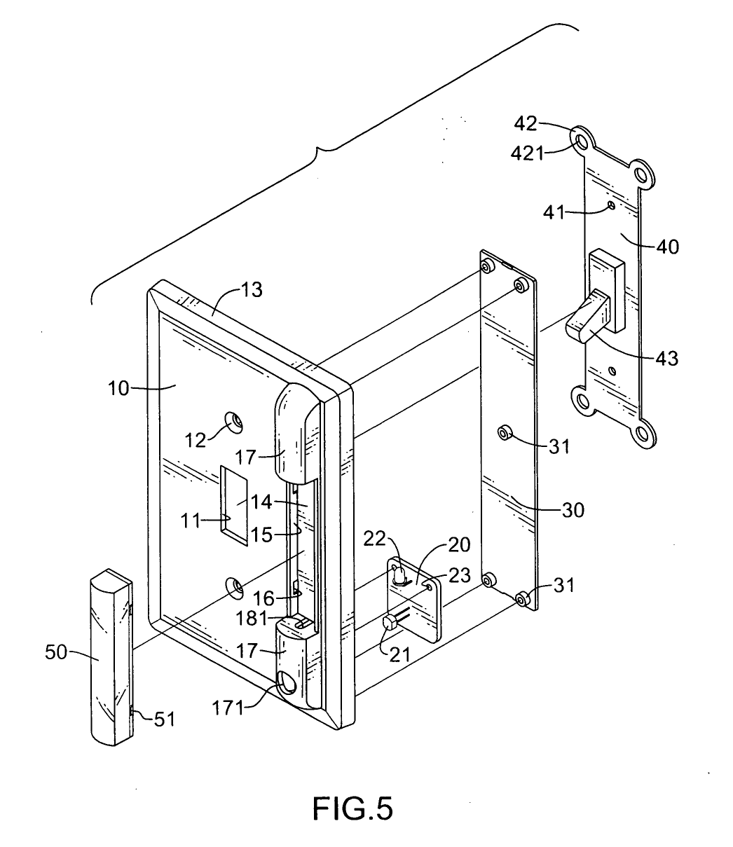

With further reference to FIG. 5, in a second embodiment of the circuit board (20), the circuit board (20) has a single lamp (22). The lamp (22) is held in one of the lamp spaces of the lamp holders (17).

The covering panel (30) corresponds to the elongated space, is attached to the rear surface of the switch panel (10), attach the circuit board (30) to the switch panel (10), covers the lamp spaces of the lamp holders (17) and has a front surface and multiple optional connecting tubes (31). The connecting tubes (31) are formed on and protrude from the front surface of the covering panel (30) and are respectively and securely mounted around the second connecting rods (191) of the switch panel (10).

The switch (43) is mounted in the switch slot (11) in the switch panel (10), is connected electrically to an illuminating device for switching on/off the illuminating device and has a rear end.

The positioning panel (40) is attached to the rear end of the switch (43) and has a front surface, a rear surface, an outer edge, multiple optional tabs (42), multiple optional positioning holes (421) and multiple optional mounting holes (41). The front surface of the positioning panel (40) is attached to the rear end of the switch (43) and abuts the mounting rods (121) of the switch panel (10). The rear surface of the positioning panel (40) is attached to the junction box in the wall. The tabs (42) are formed on and protrude from the outer edge of the positioning panel (40). The positioning holes (421) of the positioning panel (40) are respectively formed through the tabs (42) of the positioning panel (40) such that multiple fasteners can be respectively mounted through the positioning holes (421) to mount the positioning panel (40) securely on the junction box. The mounting holes (41) are formed through the positioning panel (40) and respectively correspond to the mounting holes (12) of the switch panel (10), such that multiple fasteners can be respectively mounted through the mounting holes (12) of the switch panel (10) and the mounting holes (41) of the positioning panel (40) to mount the switch panel (10) securely on the positioning panel (40).

Based on the detection of the optical sensor (21), the at least one lamp (22) is automatically lighted up when the ambient environment around the switch panel assembly is dark. The lights emitting from the at least lamp (22) are guided, refracted and scattered by the light-guiding rod (50) to light up the ambient environment and generate mild lights. With the mild lights emits from the light-guiding rod (50), sleep of the user is not interrupted. Thus, a user can easily find out the location of the switch (43) of the switch panel assembly to turn on the illuminating device in a dark environment.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

1. A switch panel assembly comprising:
a switch panel having
a front surface;
a rear surface;
an outer edge;
a switch slot formed through the switch panel; and
two lamp holders formed on and protruding from the front surface of the switch panel and each of the lamp holders having
a front side; and
a lamp space defined inside the lamp holder and communicating with the rear surface of the switch panel;
a light-guiding rod mounted on the switch panel between the two lamp holders and having
a surface; and
two opposite ends respectively abutting against the lamp holders;
a circuit board attached to the rear surface of the switch panel and having
at least one lamp mounted on and protruding from the circuit board, held in the lamp spaces of the lamp holders and aligning respectively with at least one end of the light-guiding rod to make lightemitting from the at least one lamp to be guided, refracted and scattered by the light-guiding rod; and
an optical sensor mounted on and protruding from the circuit board, held in the lamp space of one of the lamp holders and connected electrically to the at least one lamp; and
a switch mounted in the switch slot in the switch panel.

2. The switch panel assembly as claimed in claim 1, wherein the circuit board has two lamps held respectively in the lamp spaces of the two lamp holders.

3. The switch panel assembly as claimed in claim 1, wherein the circuit board has a single lamp held in one of the lamp spaces of the two lamp holders.

4. The switch panel assembly as claimed in claim 1, wherein the switch panel is transparent.

5. The switch panel assembly as claimed in claim 1, wherein
the switch panel further has a sensing hole formed through the front side of the lamp holder in which the optical sensor is held; and
the optical sensor aligns with the sensing hole.

6. The switch panel assembly as claimed in claim 1, wherein
each of the lamp holders further has a through hole formed through the lamp holder and communicating with the lamp space of the lamp holder;
the through holes of the lamp holders face to each other;
the switch panel further has an elongated recess formed in the front surface of the switch panel between the two lamp holders and having a sidewall;
the light-guiding rod is mounted in the elongated recess of the switch panel; and
the opposite ends of the light-guiding rod respectively engage with the through holes of the lamp holders.

7. The switch panel assembly as claimed in claim 6, wherein
the elongated recess of the switch panel further has multiple detents formed in the sidewall of the elongated recess; and
the light-guiding rod further has multiple bosses formed on the surface of the light-guiding rod and respectively mounted in the detents in the sidewall of the elongated recess.

8. The switch panel assembly as claimed in claim 1, wherein the switch panel further has a skirt formed around the outer edge of the switch panel.

9. The switch panel assembly as claimed in claim 8, wherein
the switch panel further has a partition wall formed on and protruding from the rear surface of the switch panel between the lamp holders and the switch slot to define an elongated space encompassed by the partition wall and part of the skirt of the switch panel and communicating with the lamp spaces of the lamp holders; and
the switch panel assembly further has
a covering panel corresponding to the elongated space, attached to the rear surface of the switch panel, attaching the circuit board to the switch panel and having a front surface; and
a positioning panel attached to the rear end of the switch and having
a front surface attached to the rear end of the switch; and
an outer edge.

10. The switch panel assembly with light-guiding rod as claimed in claim 9, wherein
the switch panel further has
multiple mounting holes defined through the switch panel around the switch slot;
multiple mounting rods formed on and protruding from the rear surface of the switch panel, respectively corresponding to the mounting holes of the switch panel and each having
a mounting slot defined through the mounting rod and communicating with a correspond one of the mounting holes of the switch panel;
multiple first connecting rods formed on and protruding from the rear surface of the switch panel in the elongated space; and
multiple second connecting rods formed on and protruding from the rear surface of the switch panel in the elongated space;
the circuit board further has multiple mounting holes formed through the circuit board and respectively and securely mounted around the first connecting rods of the switch panel;
the covering panel further has multiple connecting tubes formed on and protruding from the front surface of the covering panel and respectively and securely mounted around the second connecting rods of the switch panel;
the front surface of the positioning panel abuts the mounting rods of the switch panel; and
the positioning panel further has
multiple tabs formed on and protruding from the outer edge of the positioning panel;
multiple positioning holes respectively formed through the tabs of the positioning panel; and
multiple mounting holes formed through the positioning panel and respectively corresponding to the mounting holes of the switch panel.
